(19) United States
(12) Patent Application Publication
(10) Pub. No.: US 2017/0258053 A1
(43) Pub. Date: Sep. 14, 2017

(54) POULTRY FEEDER

(71) Applicant: The GSI Group, LLC, Hesston, KS (US)

(72) Inventors: Ching Chua Teh, Perai (MY); Zuber Bin Mohamad, Bukit (MY); Bak Yan Goh, Penang (MY)

(21) Appl. No.: 15/310,006

(22) PCT Filed: May 15, 2015
(86) PCT No.: PCT/US2015/031080

§ 371 Date: Nov. 9, 2016

Related U.S. Application Data
(60) Provisional application No. 61/993,778, filed on May 15, 2014.

(51) Int. Cl. A01K 39/012

(52) U.S. Cl. CPC A01K 39/0125

(57) ABSTRACT

An adjustable flood-type poultry feeder is disclosed that has a drop tube adapted to be releasably secured to a feed conveyor and a feed tube where the drop tube and the feed tube are movable relative to one another and have flood windows that can be selectively opened and closed by moving the drop tube and the feed tube relative to one another.

### CROSS-REFERENCE TO RELATED APPLICATIONS

This application claims priority to U.S. Provisional Application No. 61/993,778, filed on May 15, 2014, which is herein incorporated by reference in its entirety.

### STATEMENT REGARDING FEDERALLY SPONSORED RESEARCH OR DEVELOPMENT

Not Applicable

### BACKGROUND OF THE INVENTION

Field of Invention

This disclosure relates to poultry feeders, and more particularly to poultry pan feeders offering multiple feed levels that can be readily set or adjusted.

Description of Related Art

In large poultry raising operations, the birds are typically housed in a long poultry house and are fed by a large number of feeders that are supplied with feed from a bulk feed tank outside of the poultry house where the feed is delivered to the feeders by a feed conveyor. The feeders and the conveyor may be raised clear of the floor by means of winch and cable system installed in the roof of the poultry house to allow for cleaning of the floor and the introduction of new bedding material. With new bedding material installed on the floor, the feeders are lowered to the floor and a new flock of young chicks is introduced into the poultry house.

Generally, there are at least two types of feeders now in use. One type of feeder has an adjustable height feed pan, such as the Hi-Lo® feeder available from the Cumberland division of The GSI Group, LLC of Assumption, Ill. Adjustable height feed pan feeders are shown, for example, in U.S. Pat. Nos. 5,311,839, 5,462,017, 5,718,187 and 7,647,888. In these last-mentioned feeders the feed pan has a relatively small amount of feed introduced into the feed pan. The initial height of the feed pan is relatively low so that the young chicks can see the feed and can readily access the feed. As the birds consume feed, the conveyor system can be actuated to add a small amount of feed to each of the feed pans. Because of a lost motion connection between the feeder and the pan, as the birds grow, the winch and cable system is operated to raise the feeders, which, in turn, increases the depth of the pan. The initially shallow depth feed pan allows the young birds to access the feed in the feed pan, and, because only a small amount of feed is deposited in the feed pan and because feed may be periodically added to the feeder, a steady supply of feed is maintained in the feed pan that will not go stale or be fouled before it is consumed. Then, as the birds grow, the feed pan depth can be increased while allowing the now larger birds to still access the feed and allowing more feed to be deposited in the feed pan without the birds raking feed from the feed pan. These adjustable depth feeders have resulted in shorter times from a flock to reach a desired market weight of the birds and in lower feed consumption.

The other type of feeder is known as a flood feeder in which a feed pan is flooded with feed for feeding young chicks. While this allows young birds to access the feed and to have a sufficient quantity of feed, such prior art flood feeders were typically not readily adjustable to offer different pre-set levels of feed for the birds. Reference may be made to U.S. Pat. Nos. 5,092,274, 6,173,676, 7,107,932, 7,228,697 and 7,552,697, which disclose prior art flood feeders in the same general field as the present disclosure.

### BRIEF SUMMARY OF THE INVENTION

Briefly stated, a poultry feeder is disclosed that is configured to be installed on a feed conveyor, the latter comprising a feed conveyor tube through which feed is conveyed to one or more of the feeders positioned along the feed conveyor tube. The feeder comprises a feed pan, a drop tube in communication with the feed conveyor for receiving feed therefrom and for discharging feed from the bottom of the drop tube into the feed pan, and a grill connected to the drop tube assembly and the feed pan. The grill has a grill ring at its upper end that receives a feed level tube with the grill and the grill ring being rotatable and axially movable with respect to the feed level tube. The feed level tube receives the drop tube therein and the drop tube is axially movable relative to the feed level tube. The feed level tube and the drop tube each have one or more flood windows that are movable relative to one another so as to open and close the flood windows. The grill ring preferably has internal threads and the feed level tube has external threads that threadably engage one another for adjustably axially moving the feed level tube with respect to the grill pan, for purposes as will be described.

The feeder of the present disclosure features a slide gate valve that allows the feeder to be readily adjusted to allow predetermined amounts of feed to be readily set or indexed for the feeder.

In accord with the feeder of the present disclosure, the feeder allows for the ready and easy adjustment of the amount of feed that is allowed to enter the feed pan so as to correspond to a plurality of predetermined feed levels.

Still further, the feeder of the present disclosure allows the feeder to be readily disassembled for cleaning and to be readily reassembled without the use of tools.

The feeder of the present disclosure may be readily connected to and disconnected from the feed conveyor.

The feeder of the present disclosure has grill spokes that reduce the space occupied by the spokes thus accommodating more birds to simultaneously feed in the feeder, and grill spokes that minimize the danger of entrapping young birds in the feeder.

A feeder of the present disclosure may have a feed pan that is hinged relative to the grill of the feeder thus allowing the feed pan to swing down for ease of cleaning and that has one or more latches to secure the feed pan to the grill, where such unlatching and latching of the feed pan may be readily accomplished without the use of even simple hand tools.

Further, the grill pan of the present disclosure may have a low rim height thus allowing day-old chicks to feed from the pan and may have a sloped rim thus allowing young birds to access the feed in the feed pan and to minimize injury to the birds as they access the feed in the feed pan.

In accord with the feeder of the present disclosure, the feed level tube has a feed level skirt on its lower end with the skirt having a plurality of anti-scratch fins that are spaced between the spokes of the grill so as to cooperate with the spokes of the grill thereby to form equal feed access spaces for the birds thus minimizing the waste of feed that is due from the bird's natural tendency to rake the feed with their feet.

Other objects and features of the feeder of the present disclosure will be in part pointed out and in part apparent to those of ordinary skill in the art.

### BRIEF DESCRIPTION OF THE SEVERAL VIEWS OF THE DRAWINGS

FIG. 1 is a perspective view of the feeder of the present disclosure;

FIG. 2 is a view similar to FIG. 1with ¼ of the feeder shown in cross section to illustrate the relationship of the various components of the feeder;

FIG. 3 is a view similar to FIG. 2 further showing a feed conveyor tube and conveyor auger received in the upper region of the feeder for delivering feed to the feeder;

FIG. 4 is a side elevational view of the feeder shown as it is operatively connected to a feed conveyor with the right-hand half of the feeder shown in cross section;

FIG. 5 is a top plan view of the feeder taken along 5-5 of FIG. 4;

FIGS. 6A and 6B are, respectively, front and right side elevational views of the feeder;

FIGS. 7A and 7B are, respectively, top and bottom plan views of the feeder;

FIG. 8 is an exploded perspective view of the feeder;

FIG. 9 is a perspective view of the grill assembly of the feeder;

FIGS. 10A-10C illustrate, respectively, perspective, top plan and side elevational views of the grill assembly;

FIGS. 11A and 11B illustrate different perspective views of the feed level tube;

FIG. 12 is a perspective view of the drop tube assembly;

FIGS. 13A, 13B illustrate different perspective views of the feed level tube, and FIGS. 13C, 13D illustrate different side elevational views of the feed level tube;

FIG. 14A illustrates a perspective view of the drop tube;

FIG. 14B is a view similar to FIG. 14A with portions of the drop tube shown in cross section;

FIG. 14C is a vertical cross sectional view of the drop tube taken along a plane coplanar with the center axis of the feeder and perpendicular to the axis of the feed conveyor;

FIG. 14D is a vertical cross sectional view of the drop tube taken along a plane containing the axis of the feed conveyor;

FIG. 15A is a perspective view of the feed pan;

FIG. 15B is a vertical cross sectional view of the feed pan;

FIG. 16A is a perspective view of the grill and the feed level tube illustrating how the feed level tube is received in an upper grill ring and how (as shown by the arrows) the feed level tube may rotate with respect to the grill ring;

FIG. 16B is an exploded perspective view of the grill and the feed level tube and how the drop tube assembly may be axially received within the feed level tube;

FIG. 16C is a perspective view of the assembled grill, feed level tube and drop tube and illustrating how a top cap is installed on the top of the drop tube so as to secure the feeder to the feed conveyor tube (not shown);

FIG. 16D is a perspective view of the assembled feeder illustrating a slide gate as it is inserted into the drop tube so as to block the flow of feed into the drop tube and having at least one gate opening for regulating the flow of feed from the feed conveyor into the drop tube assembly of the feeder;

FIG. 16E is a view similar to FIG. 16D illustrating how a feed pan is connected by a hinge to the grill with the feed pan shown in its lowered position so as to permit cleaning of the feed pan;

FIG. 16F is a perspective view of the fully assembled feeder with the feed pan in its normal position latched to the grill by one or more releasable latches;

FIG. 17A is a perspective view of the slide gate on an enlarged scale having a solid portion for blocking the flow of feed and having a slide gate opening for regulating the flow of feed into the drop tube assembly;

FIG. 17B is a view similar to FIG. 17A of another embodiment of the slide gate valve having a plurality of openings of different sizes for admitting different amounts of feed to enter the drop tube assembly, depending on which of the openings is in register with the drop tube assembly;

FIGS. 18A and 18B illustrate how gripper tabs carried by the feed level tube that lock the feed level tube to the drop tube and such that when the gripper tabs are depressed (as shown by the opposed arrows A), the grill ring and the feed level tube may rotate relative to the drop tube (as shown by the curved arrows Bs) and illustrating first and second flood feed levels;

FIGS. 19A is a top plan view of portions of the center of the feeder , and FIG. 19B is a view of a portion of FIG. 19A illustrating the alignment of an indicator arrow on the upper rim of the feed level tube with feed level position indicia on the grill ring;

FIG. 19B is an enlarged view of a portion of FIG. 18A illustrating a snap bump carried by feed level latched to the grooves on the grill ring;

FIG. 20A is a vertical cross sectional view of the feeder illustrating the relationship of the grill, grill ring, feed level tube and the drop tube;

FIG. 20B is an enlarged scale view of a portion of FIG. 20A illustrating details of the grill ring, the upper rim of the feed level tube, the threads on the grill rim and the feed level tube and how these members cooperate with one another;

FIG. 21 is a top plan view of a portion of the feeder illustrating axial grooves in the drop tube that cooperate with gripper tabs on the feed level tube and how when the tabs are depressed into the axial grooves of the drop tube the grill may be rotated relative to the feed level, and illustrating indicia on the upper surface of the grill rim indicative of different flood feed levels;

FIGS. 22A, 22B illustrate how different flood level feed conditions between level 1 (minimum flood level, as shown in FIG. 22A) and level 6 (maximum flood level, as shown in FIG. 22B) upon winching down the feed conveyor system with the feed pans resting on the floor of the poultry house;

FIGS. 22C and 22D illustrate certain winch up conditions that shut off flood feed and that adjust the amount of feed flowing into the feed pan from the bottom of the drop tube upon raising the feed conveyors and feeder by means of the winch and cable lifting system; and

FIG. 23 is a perspective view of a top cap for the feeder on an enlarged scale.

Corresponding reference characters indicate corresponding parts throughout the several views of the drawings.

### DESCRIPTION OF PREFERRED EMBODIMENTS

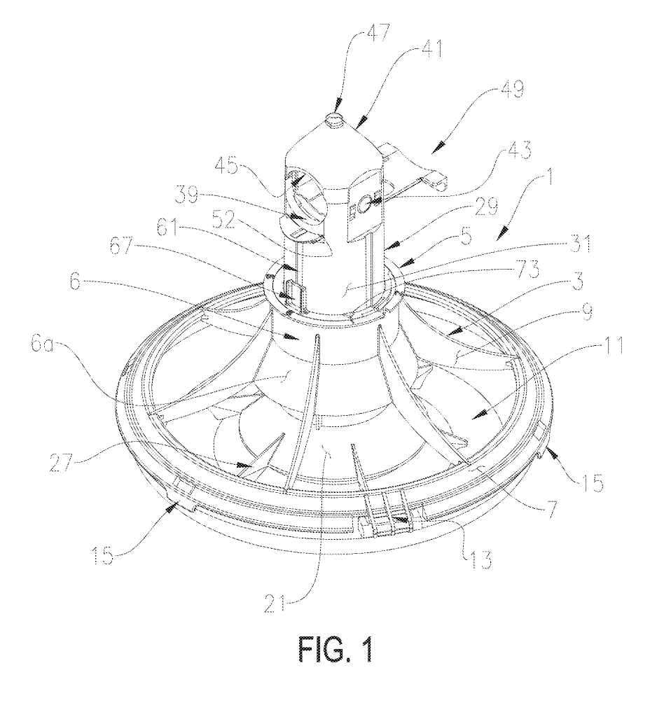

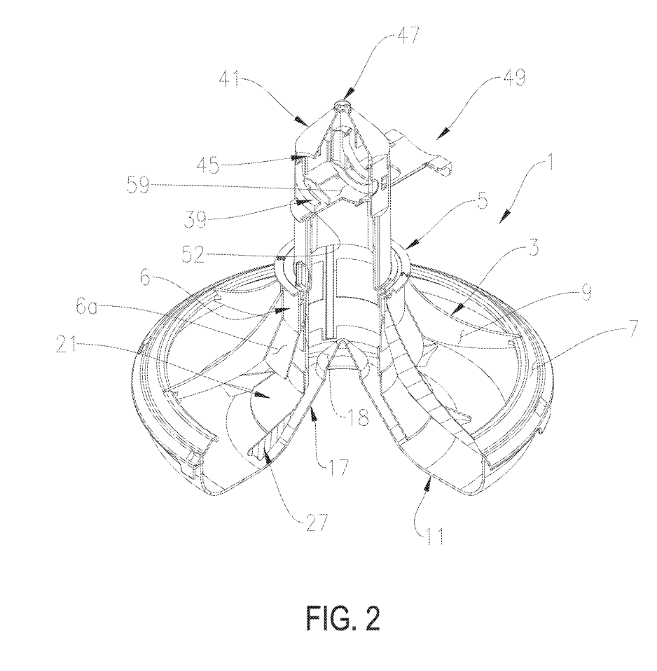

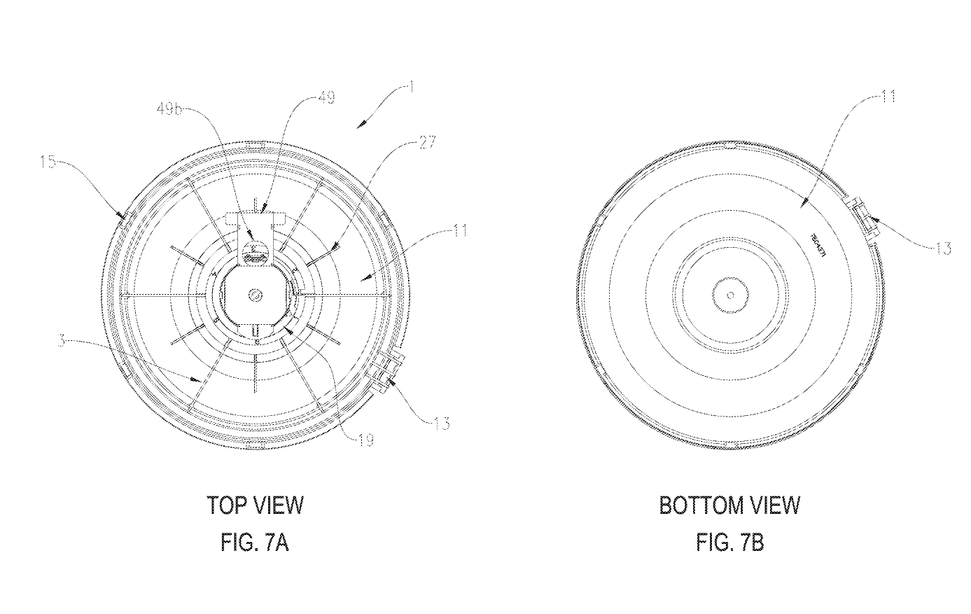

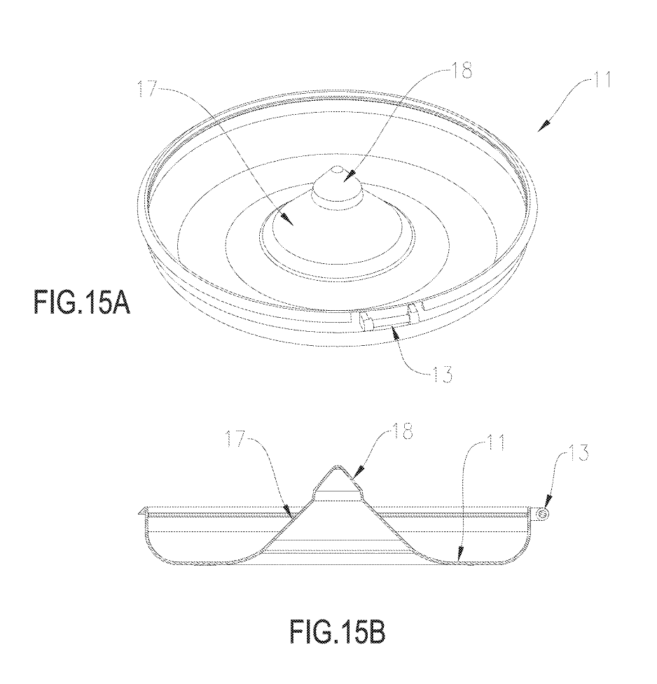

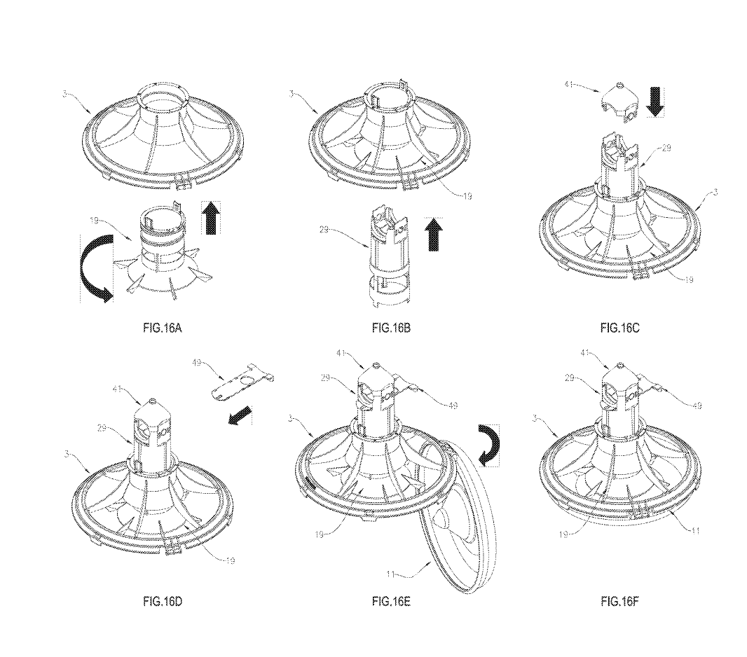

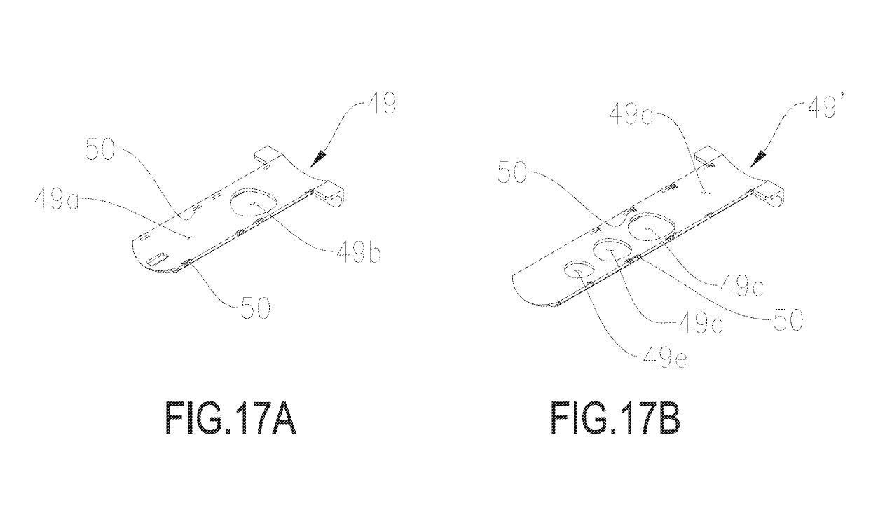

Referring now to the drawings, and more particularly to FIGS. 1-8, a poultry feeder, such as a broiler pan feeder, of the present disclosure is illustrated in its entirety by reference character 1. The feeder comprises a grill assembly, as generally indicated at 3, having an upper grill ring 5, a lower rim 7 and a plurality (e.g., six) spokes 9 extending between the upper grill ring 5 and the lower rim 7. The grill assembly includes a tubular body 6 whose lower end is flared outwardly, as indicated at 6 a. The feeder further has a feed pan, as generally indicated at 11, having a hinge 13 for hingedly connecting the feed pan to the grill rim 7 and a plurality of latches 15 that may be snap locked to secure the feed pan in its operating position, as shown in FIG. 1. As shown in FIG. 16E, the latches 15 may be unlatched so that the feed pan is free to swing downwardly to for cleaning purposes. As shown in FIG. 2, the feed pan has a raised cone center cone 17 with a smaller cone 18 at the top of the center cone.

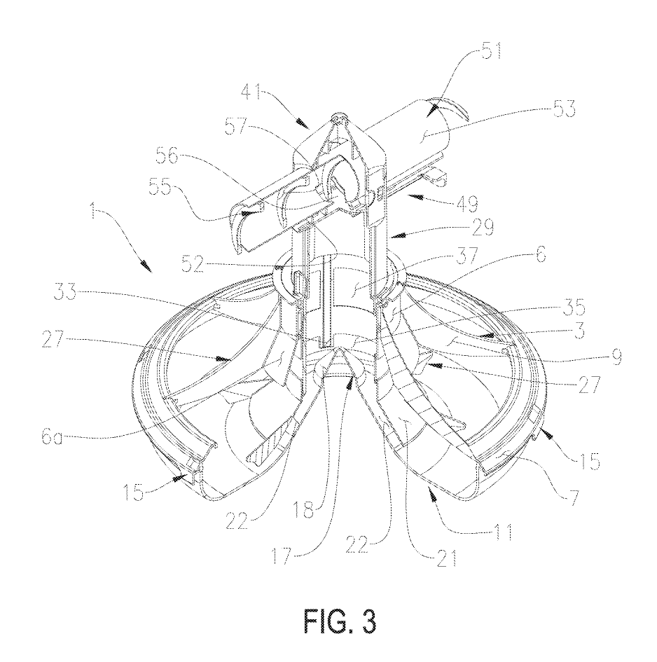

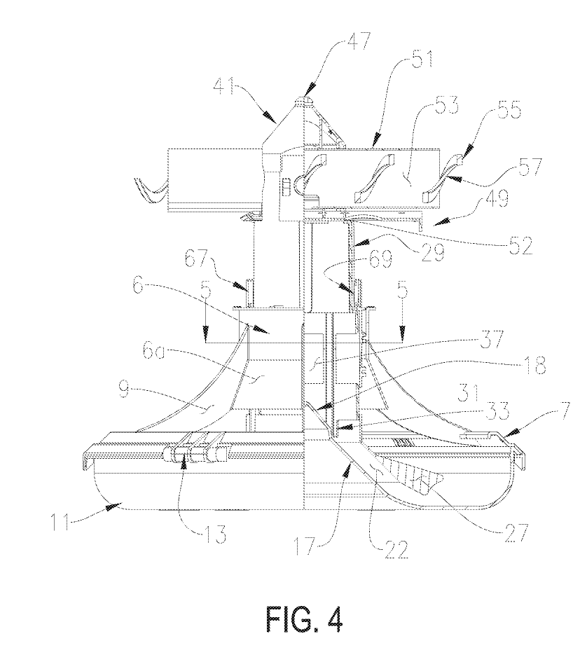

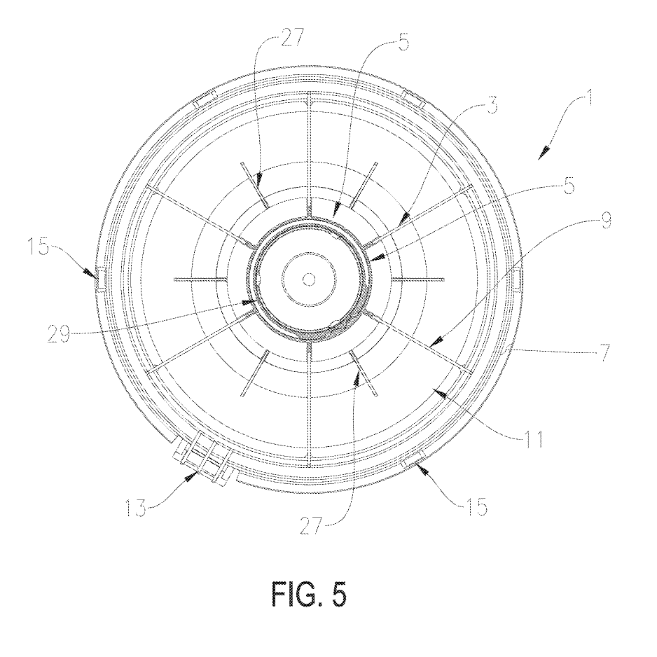

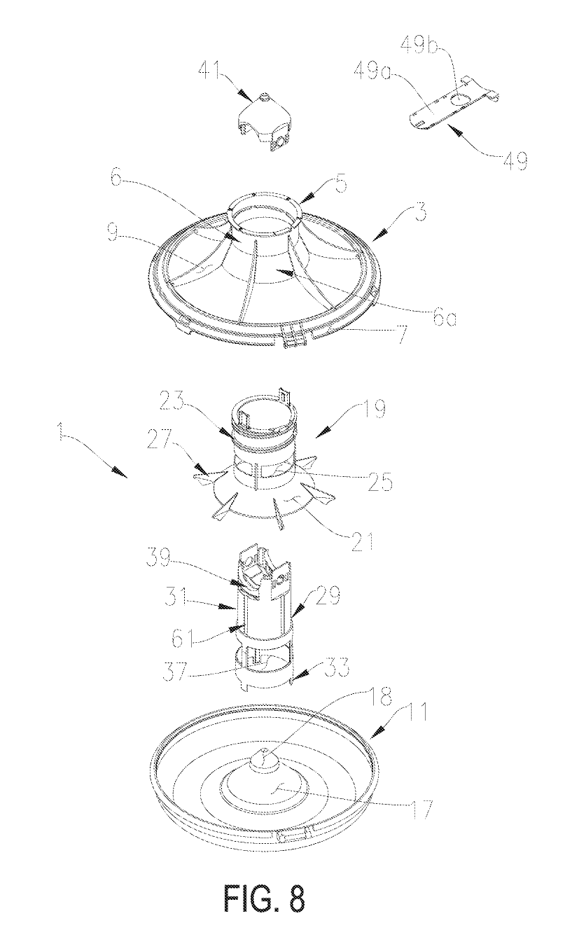

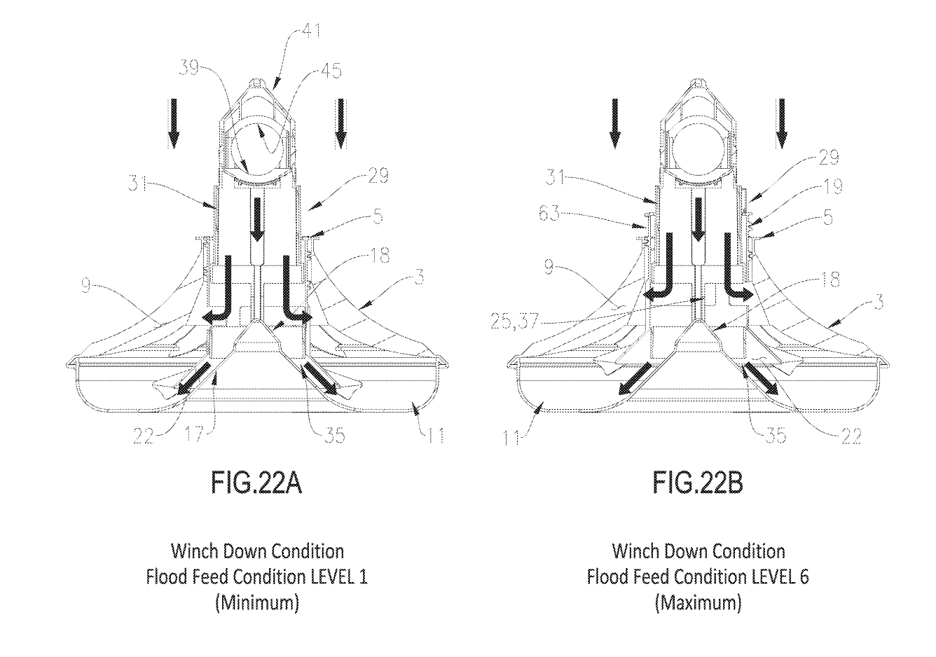

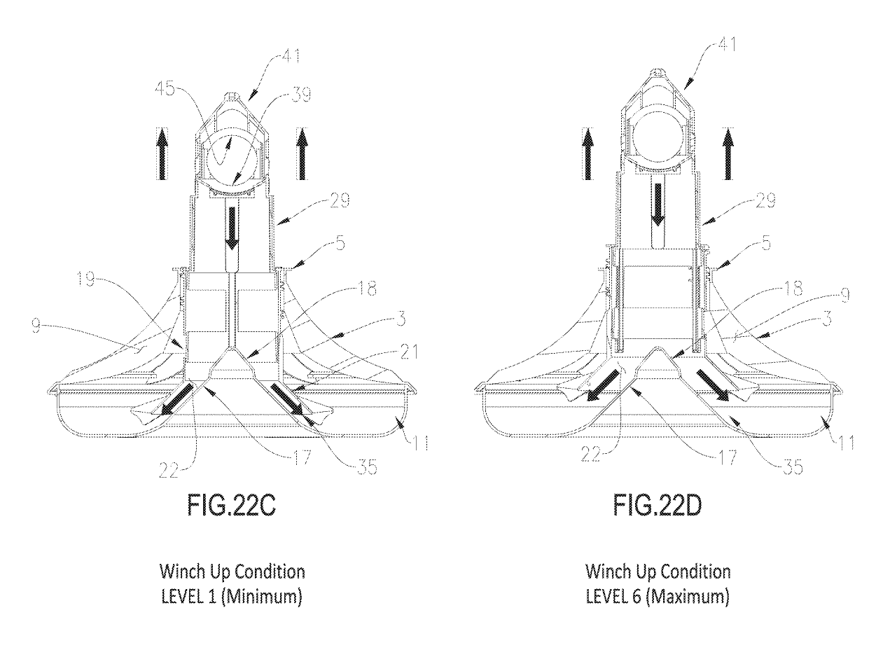

As shown in FIG. 8, feeder 1 further comprises a feed level tube assembly, as generally indicated that 19. This feed level tube has a feed level skirt 21 at its lower end, a feed level tube 23, and one or more openings or flood windows 25 in the feed level tube above the skirt. A plurality of anti-scratch fins 27 are preferably equally angularly spaced around skirt 21. These fins inhibit or minimize the tendency of birds to scratch feed from the feeder. As shown in FIG. 5, these anti-scratch fins 27 are spaced between spokes 9 of grill assembly 3 so that the spokes and the fins provide substantially equal spaces for birds to feed. The spacing of the grill spokes 9 and anti-scratch fins 27 is such that it discourages young birds from staying too long in the feeder so as to allow other birds to feed and to prevent birds from sleeping in the feeder because of a lack of space. It will be appreciated that with the feed tube assembly 19 in its operative position, as perhaps best shown in FIGS. 3 and 4 and in FIGS. 22A-22D, there is a space 22 between the upper surface of feed pan cone 17 and the underside of skirt 21 for establishing a layer of feed on the feed cone and a pile of feed in the bottom of pan 11.

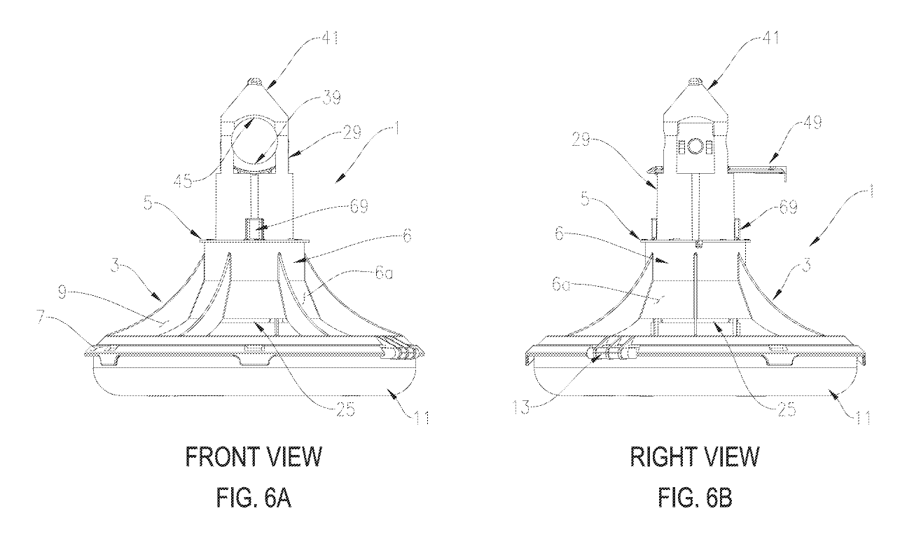

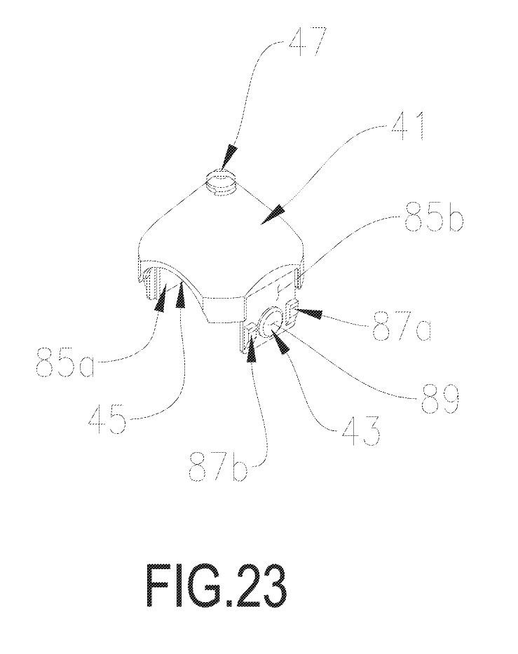

Still further, feeder 1 includes a drop tube assembly 29 that includes a drop tube 31 having feet 33 (See FIG. 8) on its bottom end that engage the upper surface of the feed pan cone 17 during feed flood or winch down position so as to positively establish a space or gap 35 (see FIG. 3) between the upwardly facing surface of the feed pan cone 17 and the bottom edge of the drop tube to prevent feed from being blocked. One or more (and preferably a plurality of) flood windows 37 are spaced around the drop tube. The upper end of drop tube 29 has an opening 39 (as shown in FIG. 6A) for receiving a lower portion of a conveyor tube 53 (as will be described hereinafter). A top cap 41 (as best shown in FIGS. 1 and 23) is releasably secured (snap locked) to the upper end of the drop tube by a releasable latch 43. The top cap has an opening 45 which is adapted to receive an upper portion of a feed conveyor tube 53 (as will be hereinafter described). At the upper end of the top cap 41, an attachment 47 is provided for an electrified anti-roost wire.

A slide gate valve, as generally indicated at 49 and 49′ as shown in FIGS. 17A and 17B is provided in the upper portion of the drop tube to selectively block the flow of feed into the drop tube or to allow and to regulate the amount of feed to enter the drop tube from the conveyor system. As shown in FIG. 17A, slide gate valve 49 has a solid portion 49a, which is preferably curved to substantially match the radius of conveyor tube 53 and which when it is in register with an opening to drop tube 56 (as described below) blocks the flow of feed from the conveyor tube into the feeder. The slide gate further has at least opening 49b for admitting feed from the feed conveyor to flow into the drop tube assembly when the opening 49b is in register with opening 59 (described below) in the upper end of the drop tube assembly 29. Alternatively, as shown in FIG. 17B, the slide gate 49 valve may have a plurality of openings 49c-49e therein of different sizes spaced along the slide gate to regulate the flow of feed into the drop tube assembly. The slide gate is provided with stops 50 that latch the slide gate relative to the drop tube in different positions so as to fully block, partially open, or fully open opening 49b (or to open or partially open one of the plurality of different sized openings 49c, 49d, 49e) in register with an opening 59 (as will be further described below) in the drop tube assembly so as to have a high, medium and low supply of feed from the conveyor tube into the drop tube, as determined by how much of opening 49a (or which of the plurality of openings) in the slide gate is (are) in register with opening 59 so that the amount of feed discharged from the feed conveyor into the upper portion of the drop tube may be selectively controlled or regulated. It will be appreciated that in some operating circumstances, it may be desirable for an operator to be able to block the flow of feed to certain of the feeders in a poultry house. Thus, slide gate 49 provides an easy way for such feeders to be de-activated without having to remove the feeder from the feed conveyor system. Further, the slide valve 49 with its different opening sizes, as indicated at 49a, 49b and 49c in FIG. 17, allows feeder 1 to be programmed (indexed) to properly deliver feed for longer feeding line by minimizing the time lag (between the first pan feeder vs the last pan feeder in a long feeding line). While the openings 49a-49c are shown in FIG. 17 to be circular openings, it will be appreciated that they could be of other shapes, such as rectangular. It will also be appreciated that by merely looking at the position of the slide gate valve, the amount that the valve extends from the drop tube assembly 29, a poultry house attendant can verify whether a feeder 1 is fully blocked or whether a predetermined flow of feed from the feed conveyor is admitted into the drop tube assembly. In this manner feed may be readily distributed to various feeders 1 along the feed conveyor in a prescribed manner. In turn, this feature minimizes feed wastage.

Preferably, the main components for feeder 1, including grill assembly 3, feed pan assembly 11, feed level tube assembly 19 and drop tube assembly 29 are injection molded (or otherwise formed) of a suitable synthetic plastic material, such as a polypropylene resin. Thus, it will be understood that certain parts of the feeder 1 may be resiliently flexible purposes as will be hereinafter described.

As shown in FIGS. 3 and 4, a feed conveyor 51 delivers feed that is typically stored in a bulk feed tank (not shown) located outside of the poultry house (also not shown) in a manner well known to those skilled in the art. The feed conveyor comprises a rigid conveyor tube 53 that extends a relatively long distance within the poultry house and has a multiplicity of feeders 1 operatively connected to the conveyor tube at spaced intervals therealong. As is well known to those skilled in the art, the feed conveyor tube 53 has a plurality of bottom-facing openings 56 (as shown in FIG. 3), one for each feeder 1, preferably spaced along the length of the feed conveyor tube so that feed conveyed by the feed conveyor may be delivered to each of the feeders upon operation of the feed conveyor. The feed conveyor tube is typically suspended from the ceiling or roof of a poultry house by means of a well-known winch and cable assembly (not shown) that may be selectively operated to raise or lower the conveyor tube and all of the feeders connected thereto. In operation, the winch and cable assembly is adjusted so that the feed pans 11 of the feeders rest on the floor of the poultry house. The winch may be operated to begin to lift the feeders 1 from the floor (as will be discussed in greater detail hereinafter) and may be operated to lift all of the feeders well above the floor to allow for the ready cleanout of the poultry house and the addition of new bedding material. Once the new bedding is in place, the winch system is operated to lower the feeders onto the bedding. It will be understood by those skilled in the art that some poultry houses have a slatted floor that does not require the use of bedding material, in which case the feeders 1 of the present disclosure will rest directly on the slatted floor.

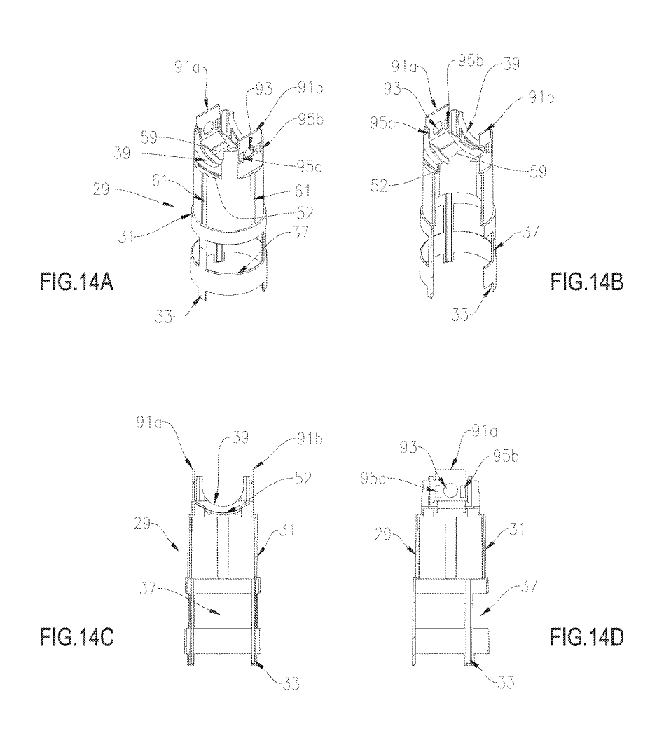

As is typical, conveyor 51 has a center-less, flexible auger 55 located within tube 53 with the auger having a multiplicity of flights 57, where a “flight ” is one spiral or convolution of the auger 55. It will be understood that upon operation of the conveyor 51, the auger 55 will convey feed through tube 53. As shown in FIG. 3, at each feeder location along the conveyor tube, an opening 56 is provided in the bottom of the conveyor tube. An opening 59 (as best shown in FIGS. 14A and 14B) in the upper reach of drop tube 31 below the level of slide gate 49 receives feed from its respective opening 56 in the conveyor tube 53. With slide gate 49 or 49′ in one of its open positions with its openings 49a or one of its openings 49b or 49c-49e in register with opening 59, a flow path is established for feed from the conveyor tube 53 to flow into drop tube 31. The feed will flow through the interior of the drop tube and will flow out of the bottom of the drop tube through space 35 (see FIGS. 22A-22D) at the bottom of the drop tube and through space 22 between the upper surface of the cone 17, as shown in FIGS. 3 and 4, and will form a layer of feed on the upper surface of cone 17 and in the feed pan 11, as previously described, but not shown in the drawing figures. It will be understood that feed from within the drop tube will also flow through windows 37 in drop tube 31 and through windows 25 in feed level tube 23 when the windows 37 and 31 are open so as flood the feeder with feed. Periodically, at either the discretion of an operator or at pre-programmed times, the feed conveyor system may be actuated to deliver additional amounts of fresh feed to each of the feeders 1. It will be appreciated that as feed flows from the bottom of the drop tube 31 through the space 35 and on to the upper face of the pan cone 17, at the bottom of the cone 11 a pile of feed will build up until the feed reaches a certain depth in the feed pan (as established by the size and shape of the feed pan, the height of space 22 between the upper surface of the feed pan cone and the underside of skirt 21, and the angle of repose of the feed). When the pile of feed blocks the flow of feed from space 22, the further flow of feed from space 22 is blocked and no additional amount of feed will flow through the drop tube and into the feed pan even though feed may be present in the drop tube. In this manner, the amount of feed deposited in the feeder when the flood windows 25 are closed is self-limiting, even when the feed conveyor (as will be described) continues to operate so as to deliver feed to other feeders along the conveyor. In other words, the feeders 1 of the present disclosure will not be overfilled.

As shown in FIGS. 8 and 16A-16F, drop tube 29 is received within feed level tube 19, which, in turn, is received within grill ring 5 of the grill assembly 3. It will be appreciated that these members may move both axially and rotatably relative to one another for purposes as will appear. As shown in FIG. 14A, drop tube 29 has a series of axial grooves or slots 61 on it's the outer surface. As shown, there are four of such grooves 61 and they are spaced at substantially equal angular intervals (i.e., at 90° intervals) from one another and they establish four different positions between the drop tube and the feed level tube 23 for purposes as will appear. However, it will be understood that more or less than four grooves and positions may be provided.

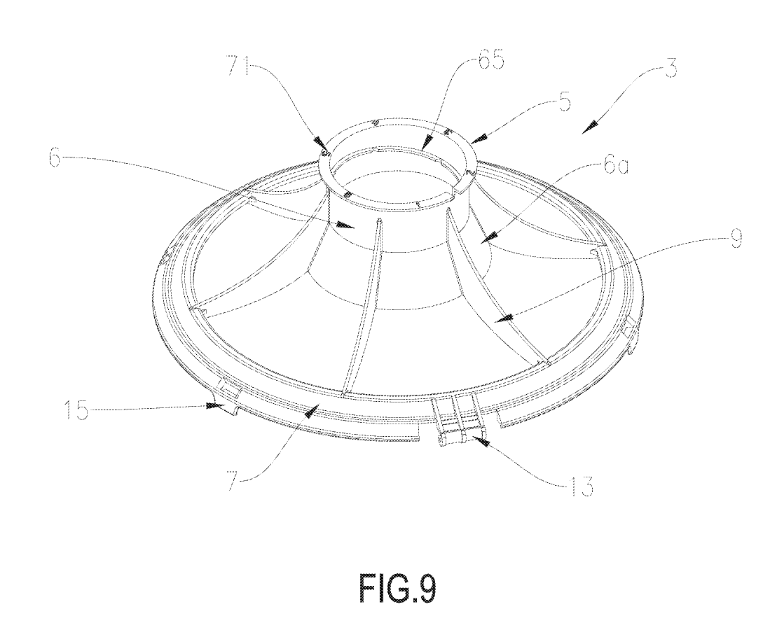

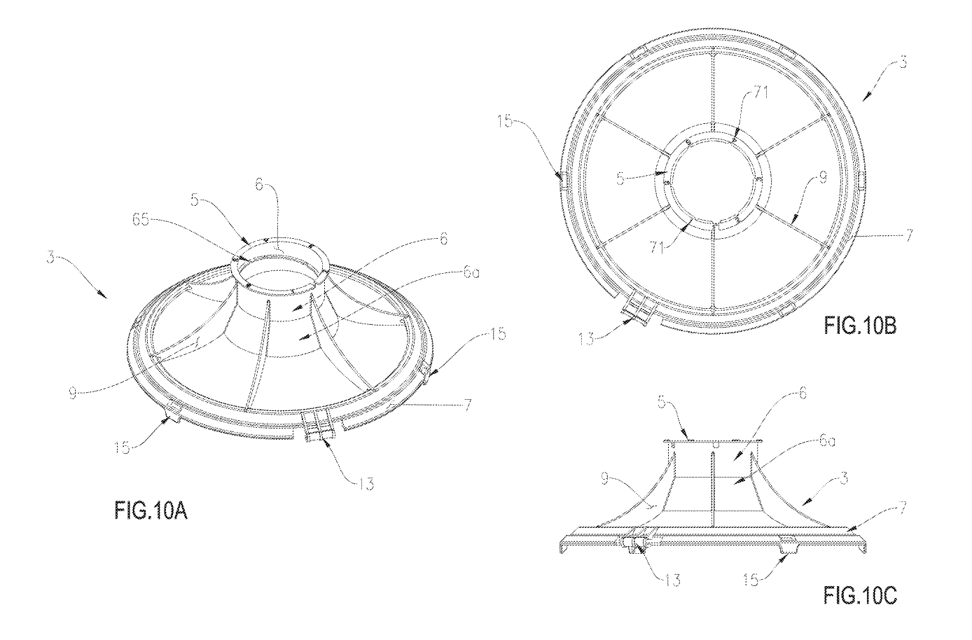

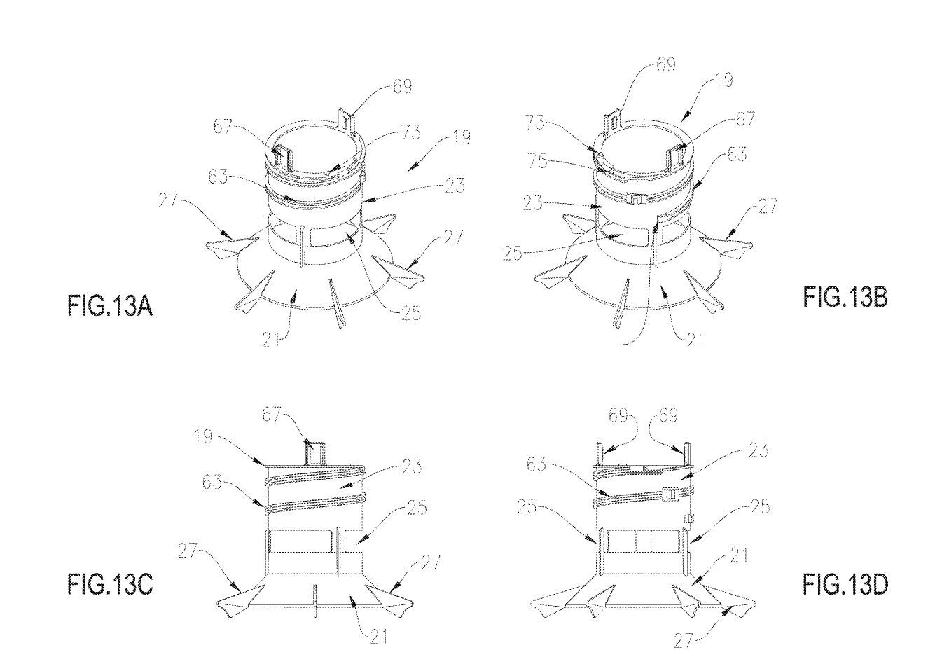

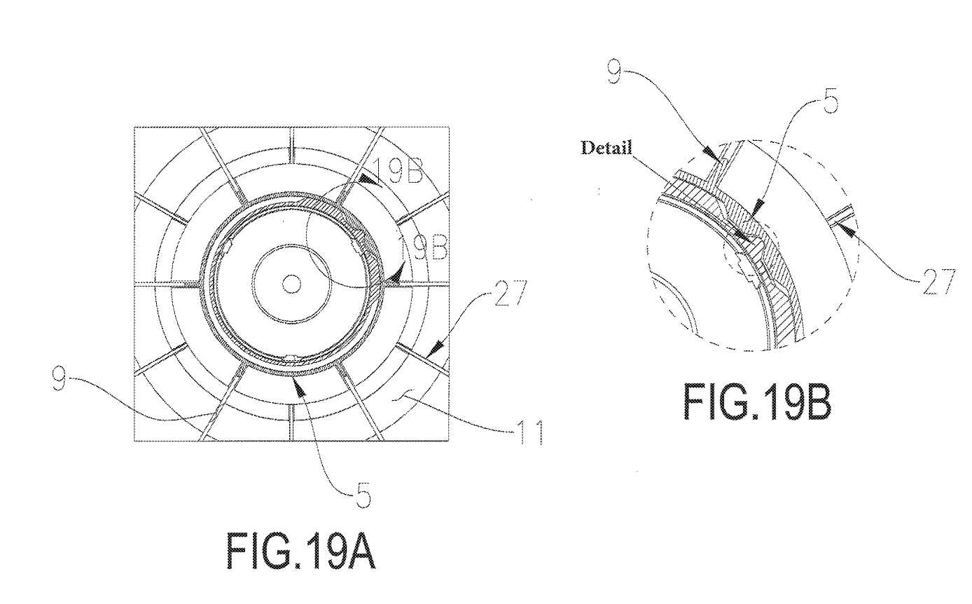

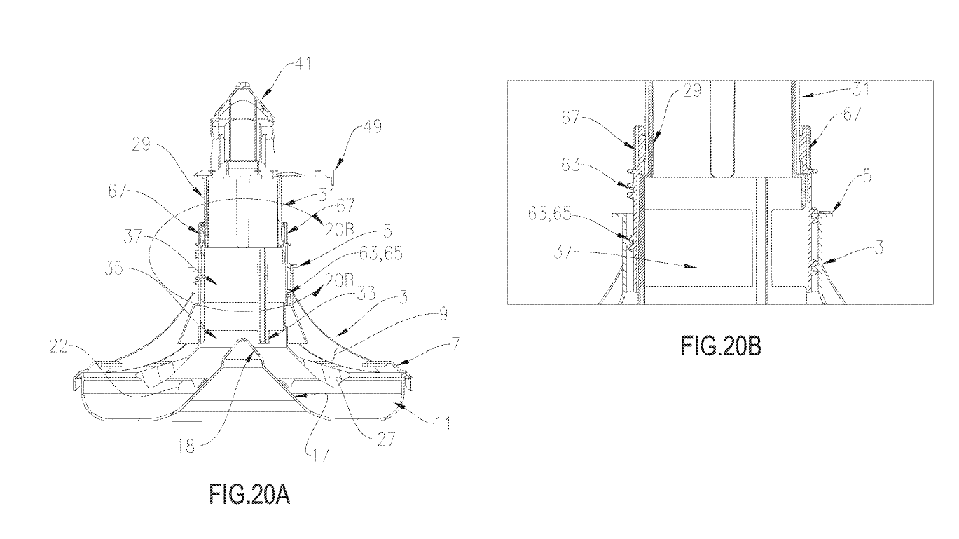

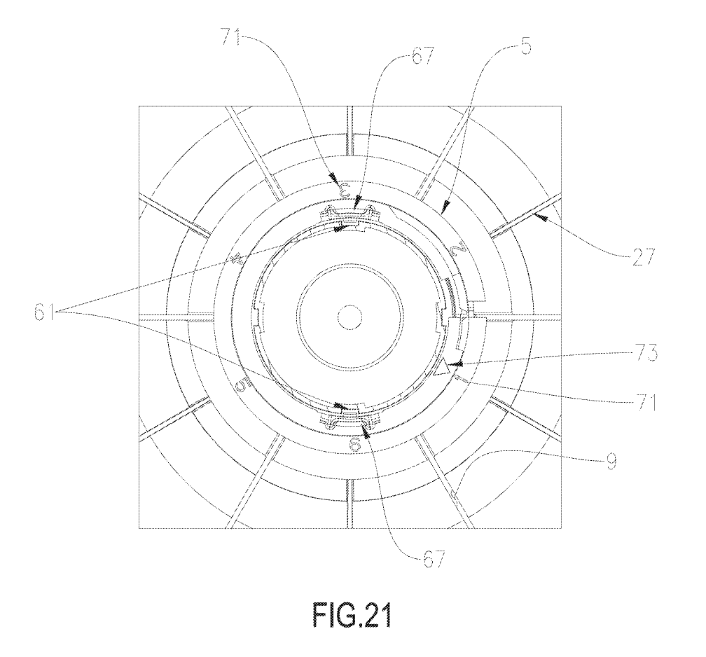

As shown in FIGS. 13A and 13B, feed level tube 23 has external threads 63 on the outside of the tube. As shown in FIG. 9, internal threads 65 are provided on the inside surface of grill ring collar 6 that threadably engage threads 63 on the feed level tube. Preferably, these threads have a pitch such that one revolution of the grill assembly 3 relative to the feed level tube 23 axially moves the feed level tube relative to grill pan 11 so as to vary the height of space 22 between its maximum and minimum. As shown best in FIG. 21, there are six indicia 71 on the upper surface of grill ring 5 spaced at about 60° from one another. Movement of the grill from one rotary position to another will adjust the feeder from one feed level to another. Movement from one level to another varies the space 22 between the underside of skirt 22 and the upper surface of grill pan cone 17 changes the space by a predetermined amount. For example, each step varies space 22 by about 4.24 mm. When arrow 73 is in register with a feed level indicia 71, a latch/dog/bump protruding from the feed level tube is received in a respective groove or notch (as shown in FIG. 9) in the grill ring's internal thread 65, as shown in FIG. 19B

The drop tube legs or feet 33, as shown in FIGS. 14A-14D, that rest on feed pan cone 17 during the winch down and flood feed positions of the feeder. The legs/feet 33 allow free flow of feed from the bottom of the drop tube to prevent stale feed from accumulating in the drop tube. Further, the axial movement of the feed level tube relative to the drop tube will move the windows 25 in the feed level tube into and out of register with the windows 37 of the drop tube so as to fully close, partially open, or fully open the windows 25, 37. It will be understood that when the feeder is in its flood feed condition; the windows 25 in feed level tube 23 are open. This is illustrated in FIGS. 22A-22D. These windows 25 have a height of about 0.75 inches (about 19 mm.). Further, it will be recognized that by rotating the grill assembly 3 relative to the feed level tube assembly 19, the space 22, as shown in FIG. 4, between the bottom face of skirt 21 and the upper surface of the pan cone 17 may be varied, which, in turn, varies the amount of feed that can be introduced into the feed pan 11.

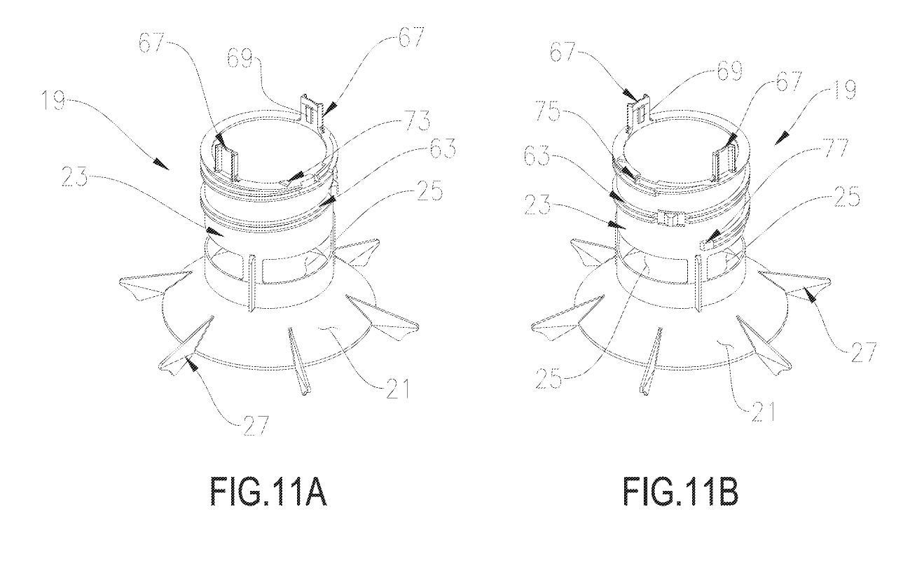

As indicated at 67 in FIGS. 1 and 11A, 11B, a pair of diametrically opposed flexible gripper tabs is provided on the upper edge of feed level tube 23. As best shown in FIGS. 11A, 11B, each of these tabs has a detent 69 on its inner face that is in register with a respective axial groove 61 of the drop tube 31. As indicated at 71 shown in FIG. 9, indicia (e.g., numbers “1”, “2”, etc.) may be provided on the upper surface of grill ring 5, preferably at substantially equal angular intervals around the grill ring, and an indicator arrow 73 (See FIG. 11A) may be provided on the upper surface of feed level tube 23 such that upon rotation of the grill assembly relative to the feed level tube such that the arrow 73 points to a desired indicia thus indicating that a pre-selected feed level supply position has been selected. As shown in the drawings, six indicia 71 are provided on the upper surface of the grill ring where the indicia are spaced around the grill ring at substantially equal angular intervals of about 60° such that six different feed level supply positions may be selected. More specifically, by depressing tabs 71 such that they are received in their respective grooves 61 and by rotating the grill assembly relative to the feed level tube, the space 22 (FIG. 4) between the bottom face of skirt 21 and the upper surface of the pan cone 17 will be increased or decreased (depending on which direction the grill assembly is rotated) for controlling the amount of feed that can be introduced into the feed pan 11 where No. 1 of the indicia 71 on the upper face of grill rim 5 denotes the least feed supply and higher indicia numbers indicate increase of feed supply amount. In the embodiment illustrated in the drawings, there are six internal grooves (as shown in FIG. 9) in grill 6 to receive the external latch (dog or bump) on feed level tube 23 (See FIG. 19B) corresponding to the indicia positions shown on the upper surface of grill ring 5. However, it will be appreciated that there could be more than or few than six adjustment positions. As shown in FIG. 11B, an upper stop 75 and a lower stop 77 prevent the feed tube 23 from becoming threadably disengaged from the grill ring 5.

Those skilled in the art will recognize that with feeder 1 in its normal operating position (i.e., not in the flood condition), the grill assembly 3, feed level tube assembly 19 and the drop pan 11 can freely rotate around the drop tube assembly 29.

In order to adjust the feed level in feeders 1, an operator operates the winch and cable system to lift the feeders clear of the poultry house floor. To adjust one of the feeders, the operator presses the tabs 67 of that one feeder inwardly so that the detents 69 on the inner face of the tabs are received in a respective axial groove 61 in the drop tube assembly 29. This locks the feed level tube assembly 19 to the drop tube assembly 29 to prevent rotation of between the feed level tube and the drop tube, but it does permit axial movement between the feed level tube and the drop tube because the detents 69 can move axially within grooves 61. The operator then rotates the grill assembly 3 relative to the feed level tube assembly 19 until the arrow 73 on the feed level tube 23 points to the desired feed level indicia 71 on the upper face of grill ring 5. Each interval of feed level 1-6 requires the grill to be rotated by 60° movement. This rotation of the grill assembly 3 relative to the feed level tube 19 causes threads 63, 65 to axially move the grill ring 5 relative to the feed level tube 23 because of the pitch of the threads. It will be appreciated that the axial movement of the grill ring 5 (along with the entire grill assembly 3 and the feed pan 11 that is attached to the grill rim 7) relative to the feed level tube results in a change in the space 22 between the underside of the skirt 21 and the upper surface of the pan cone 17.

It will also be appreciated that because the drop tube assembly 29 is axially movable relative to the feed level tube assembly 19, a “lost motion” connection is present between the drop tube 31 and the feed level tube 23. Accordingly, when the operator releases the feeder 1 and again allows the feeder to hang from conveyor tube 53, the weight of the grill 5 and pan 11 feed will cause the feed level tube assembly 19 to move downwardly with respect to the drop tube assembly 29, which in turn will cause relative axial (vertical) movement between the feed level tube 23 and the drop tube 31 so as to effect the closing of windows 25 in the drop tube and to vary the position of the flood windows vertically/axially, depending on which of the six feed level positions chosen by the operator. It will be understood that the windows 25 will be closed at all times when the feeder 1 is lifted clear of the floor (i.e., in its “winch up” condition), as shown in FIGS. 22C and 22D.

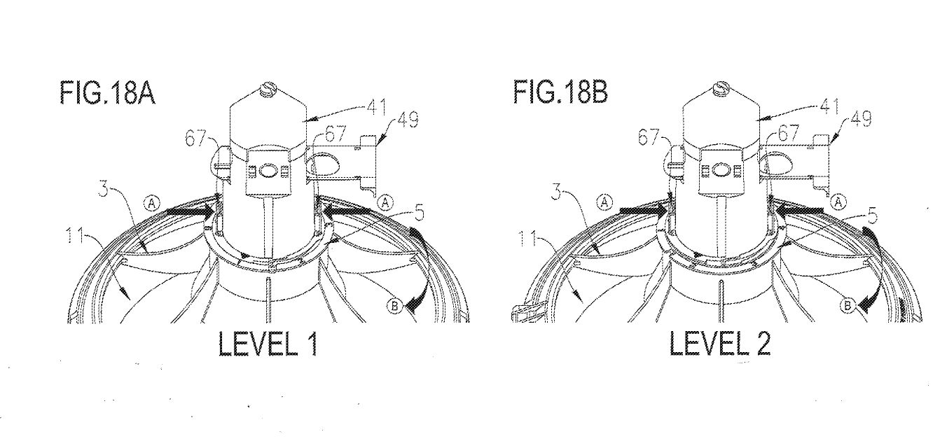

Stated another way and again referring to the drawings and particularly to FIGS. 18A and 18B, the level of the feed in pan 11 can be readily adjusted to any of the above-mentioned six feed levels (as indicated by indicia 71). An operator rotates the grill assembly 3 along with pan assembly 11 relative to the feed level tube 23 and drop tube assembly 29 until the tabs 67 on the feed level tube 23 are aligned with respective axial grooves 61 on the outer surface of drop tube 31 so that the feed level tube is dogged or latched to the drop tube so as to prevent rotation between the feed level tube and the drop tube. Then, the operator rotates the grill assembly 3 and feed pan assembly 11 as a unit relative to the feed level tube and the drop tube through an angle of about 60° until arrow 73 on the feed level tube 23 points to the desired feed level indicia 71 on the upper face of grill ring 5 and at the same time the external latch (dog or bump) on feed level 23 is received into the corresponding internal groove (as shown in FIG. 9) in grill 6. This causes rotation of the threads 63, 65 relative to one another which, in turn, effects relative axial movement between the grill ring 5 and the feed level tube 23, which in turn varies the height of space 22 between the underside of skirt 21 and the upper face of feed pan cone 17. When the feeder 1 is suspended from conveyor tube 53, the weight of the grill and feed pan will effect relative axial movement between the feed level tube 23 and the drop tube 31 so as to close flood windows 25, 37. Of course, if the flood windows are closed, no feed will flow from the windows into the feeder such that all of the feed discharged into the feeder is the feed flowing through space 35 between the underside of skirt 21 and cone 17 of the feed pan. As the flood windows 25, 37 are opened, flood feed, in addition to the feed dispensed via space 35, will also be deposited into the feeder. However, it will be appreciated that once the feeder 1 is suspended from the conveyor tube, the flood windows 25, 37 are always closed. It will be further appreciated that in this manner, the feed level may be set at any one of the predetermined feed levels corresponding to the number indicia 71 on the grill ring or on any desired intermediate position thereby to vary the amount of flood feed in the feeder 1.

As an example of the predetermined feed level settings for a feeder 1 of the present disclosure having six preset levels, the table below shows the feed capacity of the feeder when it is set at any of the six preset level setting positions, as above described, and the height of the exposed flood window openings. The feed used in this example is crumbled feed with a density of about 0.56 g/cc.

| Feed | | Height of |
|---|---|---|
| Level Position | Capacity (kg.) | Opening (mm.) |
| 1 | 0.609 | 13.3 |
| 2 | 0.699 | 17.5 |
| 3 | 0.795 | 21.7 |
| 4 | 0.844 | 26.0 |
| 5 | 0.931 | 30.1 |
| 6 | 1.018 | 34.5 |

As shown in FIGS. 22A and 22D, the minimum and maximum flood feed conditions corresponding to feed levels 1 and 6, respectively, are illustrated with the feed flow paths being illustrated by the arrows and with the relative positions of the drop tube assembly, the feed level tube and the grill being illustrated when the feeder are in a “winched down” position with the feed pan 11 resting of the floor of the poultry house. As previously described, when the feed conveyor 51 is winched up so that the feeders 1 are raised clear of the floor, the flood windows 37 are closed.

As shown in FIG. 17A, slide gate 49 has a solid curved body 49a having a single circular opening 49b that may be moved into and out of register with opening 59 in the upper portion of drop tube 31 to as to control the feed that enters the drop tube from the feed conveyor. When the slide gate is positioned such that opening 49a is fully or partly in register with opening 59, feed from the feed conveyor will be delivered to the drop tube. Of course, when the opening 40b is fully out of register with opening 59 and when the solid portion 49a of the gate valve is in register with opening 59, the flow of feed into the drop tube will be blocked. Still further, when opening 49 is partially in register with opening 59 the flow of feed may be adjusted to be an amount proportionately less than when the opening is fully in register with opening 59. As further shown in FIG. 17A, a plurality of detent stops 50 is provided on slide gate 49 that are cooperable with a slot 52, as best shown in FIGS. 1-4 and 12, in the drop tube immediately below opening into which the slide gate is inserted to support the slide gate in its fully open, fully closed or intermediate positions. FIG. 17B illustrates an alternative embodiment of the slide gate, as indicated at 49′ having multiple feed supply openings 49c-49e of varying diameters corresponding to high, medium, and low feed flows. It will be understood that more than or fewer than three different sized openings may be provided. Thus, the slide gate valves 49 and 49′ may be used to shut off the feed supply, or to control the flow of feed to the pan. This allows feeder 1 to be programmed (indexed) to properly deliver feed for long (or longer) feeding line by minimizing the time lag between the first pan feeder vs. the last pan feeder receiving feed from the feed conveyor 51 in a long feeding line. The detent stops 50 releasably position the slide gate 49′ in one of its desired positions with either solid portion 41a blocking the flow of feed or with one of its openings 49c-49e permitting the flow of feed into the lower portion of the drop tube assembly.

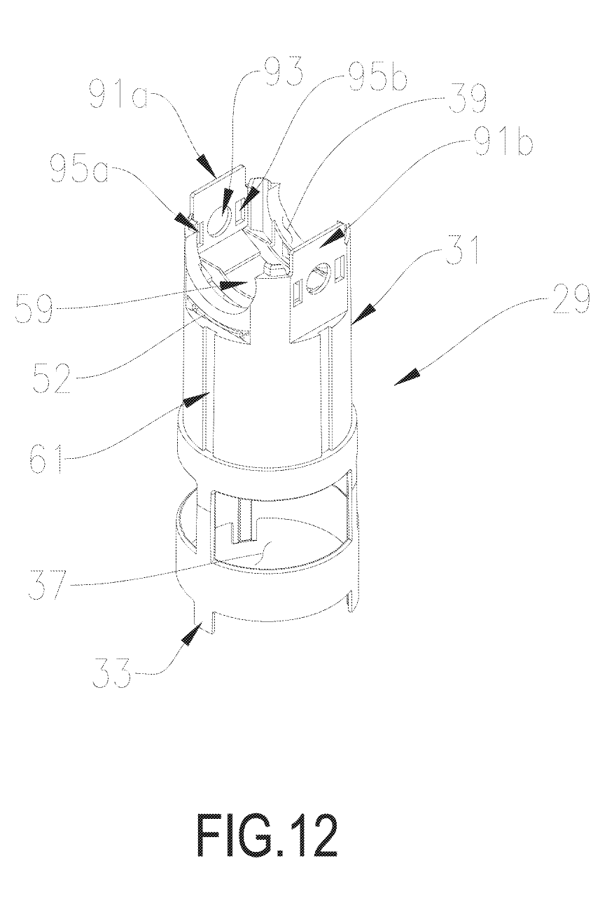

As mentioned and as shown in FIG. 23, top cap 41 has a snap lock or latch 43 on each side of the top cap for securing the top cap onto the upper end of drop tube 31. More specifically, each latch 43 is shown to be formed on a flexible (e.g., bendable or otherwise deformable) tab 85a, 85b integrally molded with the top cap and extending down from the upper portion of the top cap. Each tab carries a pair of lugs 87a, 87b and a center release button 89. A pair of receiver plates 91a, 91b (one for each tab 85a, 85b) is provided at the upper end of drop tube 31, as shown in FIG. 12. These receiver plates have a center hole 93 that receives center button 89 of the latch 43 and a pair of spaced openings 95a, 95b that receive a respective lug 87a, 87b of the latch. Thus, as the top cap 41 is installed on drop tube 31, the lugs 87a, 87b on the top cap fit within the receiver plates 91a, 91b and because the lugs 87a, 87b have sloped lower faces, these sloped faces will cammingly force the tabs 85a, 85b inwardly to allow the lugs and the center button to be received in their respective openings in the receiver plates. The resilient nature of tabs 85a and 85b will then spring back into position thus locking the top cap to the drop tube. It will be appreciated that this latch or lock is sufficiently secure so as attach the feeder 1 to the conveyor tube 53 and to support the weight of the feeder. Yet, when desired, the feeder may be readily removed from the conveyor tube without the use of even simple hand tools by manually depressing the center buttons 89, which, in turn, causes the tabs 85a and 85b to flex inwardly thus moving lugs 87a, 87b and the center release button 89 out of engagement with their respective openings in their respective receiver plates 91a, 91b such that the top cap may be readily removed from the feeder thus allowing the feeder to be removed from the conveyor tube 53.

To install a feeder 1 on a feed conveyor tube 51, at a location of a selected bottom facing outlet opening 56 of the tube, a feeder 1 with top cap 41 removed is brought into engagement with the conveyor tube at the location of a selected opening 56 and a top cap 41 is snapped into place on to the upper portion of the drop tube assembly 29 in the manner above described. It will be appreciated that the opening 39 in the upper end of drop tube assembly 29 and the opening 45 in top cap 41 are preferably sized so as to surround the conveyor tube 53 to prevent undue leakage of feed, but so as to allow the feeder to swing in a plane generally perpendicular to the horizontal axis of the feed conveyor tube such that if a bird bumps into the rim 7 of the feed pan, the feeder is not rigidly fixed relative to the conveyor tube and the feeder will rotate or swing on the feed conveyor tube. In this way, bruising of the breast of the bird is avoided which adversely affects the marketability of the bird.

With the feeders 1 installed on feed conveyor tube 53 as described, and with the conveyor tube and the feeders 1 lowered such that the feed pans 11 rest on the floor of the poultry house, the drop tube legs 33 rest or bear on the cone 17 of the feed pan. In this position, both the flood windows 37 in drop tube 29 and the windows 25 in feed tube 19 are open such that feed can flow through the windows into the feed pan, as shown by the “curved” arrows in FIGS. 22A and 22B. At the same time, as shown by the lower arrows in FIGS. 22A and 22B, feed can flow through the space 22 between the underside of skirt 21 and the upper surface of feed pan cone 17. As illustrated by FIGS. 22A and 22B, but adjusting the feeder (as above described) from its first preselected feed position (referred to as Level 1, as shown in FIG. 18A) corresponding to the position of the feeder when indicia 71 is in register with indicator arrow 73 and its Level 6 position when indicia “6” is in register with arrow 73, the amount of feed supplied to the feed pan can be varied between a minimum flood feed condition (as shown in FIG. 22A) and a maximum flood feed condition (as shown in FIG. 22B). However, it will be understood that the windows 37 and 25 are constant for all feed levels 1-6.

As the birds grow in size, the conveyor tube 53 along with the feeders 1 connected to the conveyor tube are raised, as for example by the above described winch and cable assembly, as the feed pans 11 move away from the floor of the poultry house to a so-called “winch up” condition as shown in FIGS. 22C and 22D, the above-described lost motion connection between the drop tube and the feed tube will entirely block the flow of feed through the flood windows regardless of the feed level setting of the feeder. In this “winch up” condition, the only feed that may flow into the feed pan is through the space 22 between the bottom face of skirt 21 and the upper face of pan cone 17.

While the feeder of the present disclosure has been described to be a broiler pan feeder intended for use in raising broiler chickens, it will be apparent to those skilled in the art that the feeder described herein may be used with all types of poultry, including other livestock, such as ducks and turkeys.

Referring to FIG. 12, it will be noted that the structure of drop tube 31 above legs 33 will close windows 25 of the feed level tube when the feeder is lifted above the floor thus blocking the flow of feed from the flood windows.

As various changes could be made in the above constructions without departing from the broad scope of the invention, it is intended that all matter contained in the above description or shown in the accompanying drawings shall be interpreted as illustrative and not in a limiting sense.

1. A poultry feeder configured to be installed on a feed conveyor, the latter comprising a feed conveyor tube through which feed is conveyed to one or more of said feeders positioned along said feed conveyor tube, said feeder comprising a feed pan, a drop tube adapted to be in communication with said feed conveyor for receiving feed therefrom and for discharging feed from the bottom of said drop tube into said feed pan, a grill connected to said feed pan, said grill having a grill tube adapted to receive a feed level tube, said feed level tube being adapted to receive said drop tube, said feed level tube having a skirt at its lower end spaced above said feed pan such that feed may flow between said skirt and said feed pan into said feed pan, said grill tube and said feed level tube having threads that threadably engage one another for adjustably axially moving said feed level tube with respect to said grill tube as said grill tube and said feed level tube are rotated relative to one another so as to adjust a space between the said skirt and said feed pan and to consequently adjust the amount of feed delivered to the feed pan via said space, a lost motion connection between said drop tube and said feed level tube such that with said feed pan resting on a support or floor said flood windows are open such that feed may be discharged through said flood windows into said feed pan and through said space between said skirt and said feed pan, and such that when said feeder is raised above said floor, said lost motion connection effects the closure of said flood windows.

2. A poultry feeder as set forth in claim 1 further comprising means for locking said drop tube in a desired rotary position relative to said feed level tube.

3. A poultry feeder as set forth in claim 2 wherein said locking means permits axial movement of said feed level tube and said drop tube.

4. A poultry feeder as set forth in claim 2 wherein said locking means comprises a flexible tab carried by said feed level tube that is selectively cooperable with an axial groove in said drop tube so as to prevent rotation of said drop tube relative to said feed level tube.

5. A poultry feeder as set forth in claim 1 wherein rotation of said grill tube relative to said feed level tube results in said threads effecting relative axial movement between said feed level tube and said grill tube.

6. A poultry feeder as set forth in claim 1 wherein said feed level tube has a conical skirt on its lower end, and wherein said feed pan has an upwardly extending cone such that said skirt and said cone establish a space through which feed may be introduced into said feed pan.

7. A poultry feeder as set forth in claim 1 wherein said feed level tube skirt has a plurality of spaced fins for inhibiting birds from scratching feed out of said feed pan.

8. A poultry feeder as set forth in claim 7 wherein said grill has a plurality of spaced spokes extending between said grill pan and said grill tube, and wherein said fins and said spokes alternate with one another so as to form substantially uniform sized spaces for birds to feed.

9. A poultry feeder as set forth in claim 1 further comprising a slide gate valve positioned within said drop tube, said slide gate valve being movable between a closed position in which feed from said conveyor is blocked from entering the lower portion of said drop tube and at least one open position in which feed may flow into the lower portion of said drop tube.

10. A poultry feeder as set forth in claim 9 wherein said slide gate valve has a plurality of different size openings for regulating the flow of feed from said conveyor into the lower portion of said drop tube such that the flow of feed into said feeder may be readily adjusted by moving said slide gate valve.

11. A poultry feeder as set forth in claim 1 wherein said feed pan is hingedly connected to said grill by a hinge, and one or more latches for securing said feed pan to said grill in an operative position so that upon unlatching said feed pan from said grill, said feed pan will swing downwardly on said hinge thereby to permit the ready cleaning of said feed pan, and so that upon swinging said feed pan back to its said operative position and upon securing said one or more latches said feed pan is ready for use.

12. A poultry feeder as set forth in claim 1 wherein an opening is provided in the upper end of said drop tube for receiving a portion of a feed conveyor tube, said feeder further having a top cap having an opening in its lower end for receiving another portion of said feed conveyor tube, said top cap having releasable securement tabs that when in a locked position engage the upper end of said drop tube so as to secure said top cap to said drop tube such that said feeder is secured to said feed conveyor tube and when in an unlocked position allow the feeder to be removed from said feed conveyor tube.

13. A poultry feeder as set forth in claim 12 wherein with the feeder attached to and supported by said feed conveyor tube, said feeder is substantially free to rotate about said feed conveyor tube in the event it is bumped by a bird.

14. A poultry feeder as set forth in claim 1 wherein said feed pan has a center cone extending upwardly from said pan and wherein said space is the space between said skirt and said cone.

15. A method of adjusting the amount of feed dispensed into a feed pan of a flood-type poultry feeder, said feeder having a feed pan, a drop tube adapted to be in communication with a feed conveyor for receiving feed therefrom and for discharging feed from said drop tube into said feed pan, a grill connected to said feed pan, said grill having a grill tube adapted to receive a feed level tube within said grill tube, said grill tube being rotatable and axially movable with respect to said feed level tube, said feed level tube being adapted to receive said drop tube with said drop tube being axially movable relative to said feed level tube, said feed level tube and said drop tube each having one or more flood windows that are movable relative to one another so as to open and close said flood windows, said grill tube and said feed level tube having threads that threadably engage one another for adjustably axially moving said feed level tube with respect to said grill tube as said grill tube is rotated relative to said feed level tube, a lost motion connection between said drop tube and said feed level tube, said method comprising the steps of:
rotating said grill tube relative to said feed level tube such that said threads axially move vary the space between said skirt and said feed pan cone thereby to selectively set the amount of feed discharged into said feed pan via said space;
with said feed pan resting on a support or floor, said flood windows are open so that feed may be discharged from said flood windows and from said space between said feed pan cone and said skirt; and
raising said feed conveyor so as to lift said feeder clear of said support or floor such that said lost motion connection effects the closure of said flood windows.
said flood windows relative to one another between a closed position in which flood feed is blocked from flowing into said feed pan and an open position in which flood feed flood from said windows may flow into said feed pan.

16. The method of claim 15 further comprising the step of rotating said grill tube relative to said feed level tube so as to adjust the flow of feed from the bottom of said feed level tube into said feed pan.
